(19) United States
(12) Patent Application Publication
(10) Pub. No.: US 2015/0254673 A1
(43) Pub. Date: Sep. 10, 2015

(54) Analytics Driven End of Life Product Planning

(71) Applicant: INTERNATIONAL BUSINESS MACHINES CORPORATION, Armonk, NY (US)

(72) Inventors: John M. Konopka, Tempe, AZ (US); Philip J. Poetzinger, Cary, NC (US); Anne M. Sweetland, Wappingers Falls, NY (US)

(73) Assignee: INTERNATIONAL BUSINESS MACHINES CORPORATION, Armonk, NY (US)

(21) Appl. No.: 14/514,828

(22) Filed: Oct. 15, 2014

Related U.S. Application Data
(63) Continuation of application No. 14/197,944, filed on Mar. 5, 2014.

(51) Int. Cl. G06Q 30/00

(52) U.S. Cl. CPC G06Q 30/00

(57) ABSTRACT

Embodiments include a data based methodology for projecting cumulative shipments of a product throughout the balance of its lifecycle and comparing that estimate to a proposed sales and operating plan (SOP) to drive scrap avoidance and healthy contention against the SOP that may or may not be attainable. Modelling uses critical milestones to break a product life cycle into manageable segments. One or more recommendations with respect to the SOP are provided, including supporting the SOP or changing the SOP to drive product procurement.

### CROSS REFERENCE TO RELATED APPLICATION(S)

This application is a continuation patent application claiming the benefit of the filing date of U.S. patent application Ser. No. 14/197,944 filed on Mar. 5, 2014 and titled “Analytics Driven End of Life Product Planning” now pending, which is hereby incorporated by reference.

### BACKGROUND

### Technical Field

The present invention relates to utilization of a sales and operating plan (SOP) together with a model for forecasting a remaining lifecycle for a predecessor product. More specifically, the invention relates to analysis of the SOP, including incorporation of the SOP in support of product procurement or modification of the SOP for escalation of procurement.

Prevention of excess material at the end of a product's life cycle is critical to the overall financial integrity of a hardware product offering. Transitions from a predecessor product to a new product can result in significant excess material associated with the predecessor product if the transition to the new product offering is based on flexible revenue protection strategies that rely on committed supply for both the new product and the old product. While such a transition plan may maximize revenue by allowing sale flexibility in a mix of old and new products sold during such a transition, the typical result is significant excess old material remaining. In some circumstances this is due to an overwhelming desirability of new features associated with the replacement product. At the same time, profitability associated with the new product is negatively impacted by inventory scrapped at the end of product life as well as costs associated with attempts to dispose of the excess materials. Even the new product can be sub-optimized by the end of life phase of its predecessor by the redirection of resources moved off of the new product to drive efforts to sell excess of the predecessor product and minimize scrap material.

### SUMMARY OF THE INVENTION

This invention comprises a method for projecting cumulative shipments of a product throughout the balance of its lifecycle and to forecast additional shipments for the product of interest over its remaining life cycle.

In one aspect, a method is provided for executing a model for forecasting a remaining lifecycle for a predecessor product. The model produces a first baseline curve representing shipment of the predecessor product prior to announcement of the new product and a second baseline curve from a second constructed model representing shipment of the predecessor product after announcement of the new product. A sales and operating plan (SOP) versus the executed model is analyzed, a recommendation with respect to the SOP is created. The recommendation supports the SOP to enable the SOP to drive procurement. The recommendation supports changing the SOP, and in one embodiment, includes escalating one or more parameters of the SOP and integrating new SOP with the escalation parameters into a product supply chain.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart depicting a process for periodically reviewing actual product movement in view of product forecast.

FIG. 2 is a flow chart depicting a process of employing the product model for sensitivity analysis.

FIG. 3 is a flow chart depicting a process for assessing component requirements, and an estimation of the last time to purchase components.

FIG. 4 is a block diagram depicting tools and components embedded in a computer system to support inventory management and mitigation associated with a product life cycle analysis.

FIG. 5 is a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of managers, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

Sales of a product vary over the lifespan of the product. There are several milestones related to product sales. Examples of these milestones include announcement, general announcement, follow-on announcement, withdrawal announcement, and end of manufacturing. From the start of a product release at the product announcement, sales are initiated. A pattern associated with the sales across each of these milestones may be tracked. As a subsequent product is released, or otherwise subject to an announcement or a general announcement, sales of the preceding generation of the product are affected. It is inefficient, and often considered a waste, to have product inventory remaining after the end of manufacturing. Remaining products are either sold for minimal profit, and sometimes at a loss, or the parts are scrapped for the value of the raw material. Accordingly, there is a need to gather data, study the effects of milestones on a current product, to predict behavior of the next generation product.

A data based methodology is employed for projecting cumulative shipments of a product throughout the balance of its life cycle. This projection is compared to a proposed sales plan to mitigate excess inventory and to avoid excess scrap material at the end of the life cycle. In one embodiment, the projection is compared against the SOP that may or may not be attainable. The product lifecycle is divided into multiple segments, each of the segments having a specific definition and/or characteristic. In one embodiment, each segment is handled in a different manner. Sales of the products can be tracked on different intervals, including a quarterly basis, seasonally, monthly, etc. Similarly, the effects of an announcement or release of a subsequent generation product can be tracked with respect to a current or prior product. Shipment of a new generation product affects shipment of a prior generation product. The affects have been known to cause a decrease in shipment of the prior generation product, thereby decreasing its value. In one embodiment, shipment of the prior generation may ceases, causing excess inventory of minimal value. Accordingly, there is a need to accurately and statistically estimate the effects of the new product on the prior generation product in order to mitigate availability of excess inventory.

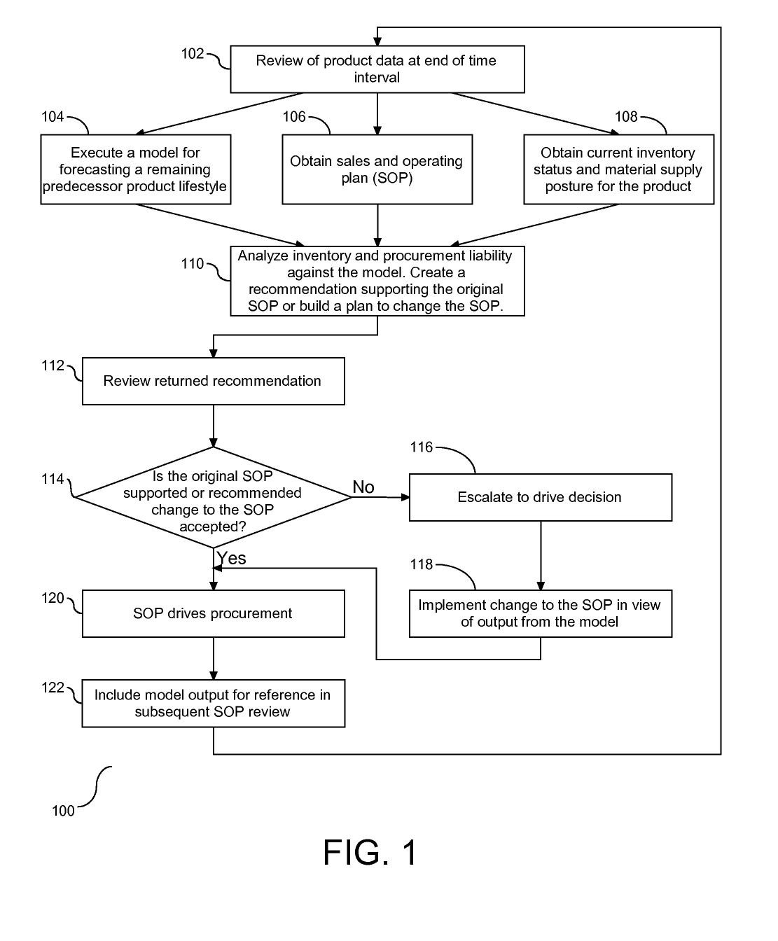

FIG. 1 is a flow chart (100) illustrating a process for periodically reviewing actual product movement in view of product forecast. In the example herein, the review is on a quarterly basis. However this time interval should not be considered limiting. In one embodiment, the period of review may be a different time interval, such as annual, semi-annual, weekly, etc. The process employed demonstrates multiple concurrent procedures for the review at the end of the time interval (102), e.g. fiscal quarter. The multiple procedures shown herein include employing a model for forecasting a remaining predecessor product lifecycle (104), obtaining the SOP plan (106), and obtaining current inventory status and material supply posture for the product (108). In one embodiment, these procedures are conducted concurrently. Accordingly, output from these procedures is employed as input for analysis the current SOP.

Execution of the forecasting model at step (104) produces two baselines curves, referred to herein as a first baseline curve and a second baseline curve. The first baseline curve represents shipment of the predecessor product prior to announcement of the new product. The second baseline curve represents a second constructed model representing shipment of the predecessor product after announcement of the new product.

Output from the model at step (104), together with data received from steps (106) and (108), is employed for analysis of the SOP forecast (110). More specifically, at step (110) an analysis of inventory and procurement liability is performed against the model to ascertain scrap or excess product (110). One goals of the SOP analysis is to minimize excess inventory and/or product material after the end of the product cycle. The analysis at step (110) includes creating a recommendation for either supporting the SOP or a build plan to change the SOP in view of the analysis. The goal(s) of the SOP, whether supported or modified, includes, but is not limited to minimization of excess inventory or product material, balancing supply and demand, avoiding wasteful production, optimizing revenue, and optimizing resources for production.

Following step (110), the returned recommendation is reviewed (112). In one embodiment, the review includes, but is not limited to, the product brand, finance, and the integrated supply chain. It is then determined if either the original SOP is supported or if recommended changes to the SOP is accepted (114). In one embodiment, changes to the SOP are based upon recommendations associated with the analysis at step (110). A negative response to the determination at step (114) is an indication that the SOP needs to be revisited and or revised to address supply line and/or supply chain concerns. In one embodiment, the negative response at step (114) is followed by a decision pertaining to entry to an escalation route (116). Entry to the route requires implementation of a change to the SOP in view of output from the model (118). Whether the SOP is changed at (118) or the prior SOP remains following a negative response to the decision at step (116), the SOP is employed to drives procurement (120). Accordingly, the SOP utilized at step (120) may be the original SOP, a revised SOP in view of output from the model, or a revised SOP based upon entry to the escalation route.

To maintain awareness of the SOP being utilized to drive procurement, output from the model executed at step (104) is included for reference in a subsequent SOP review for the remainder of the fiscal quarter (122), followed by a return to step (102). Accordingly, the original or modified SOP is employed to drive procurement and to mitigate excess inventory of the product.

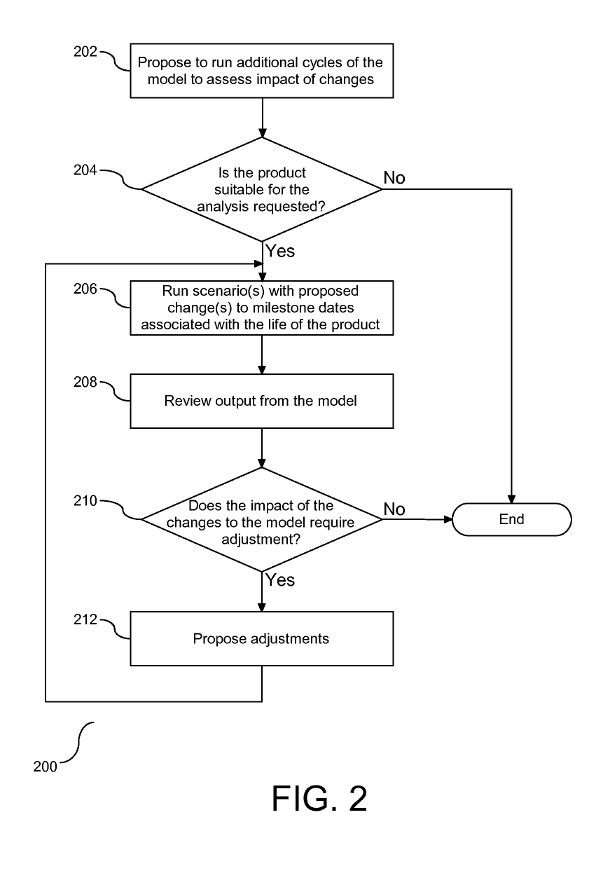

The model anticipates and/or projects product inventory and sales, and further addresses release of a related product, and how the release will affect sales of the prior product prior to phase out. FIG. 2 is a flow chart (200) illustrating a process of employing the product model for sensitivity analysis. The sensitivity analysis is initiated with a proposal to run an additional cycle of the model for a purpose other than the SOP (202). An example of such purposes includes changing a milestone, e.g. the general availability date, announcement date, etc. For example, in one embodiment, the model is employed to provide a comparison to possible different general availability dates and/or different announcement dates. In one embodiment, the model may assist in identifying impact to sales volume associated with a change to general availability of a follow-on product. Similarly, in one embodiment, the model assists in an analysis of when to end purchase of a commodity in support of the product. Based on the proposal at step (202), it is determined if the product is suitable for the analysis requested (204). The suitability relates to consistency of product transition patterns. A positive response to the determination at step (204) is followed by running one or more scenarios on the model with proposed change(s) to one or more of the milestone dates associated with the life of the product (206). Output from the model is reviewed (208). In one embodiment, the model may be run with two different and alternative general announcement dates, and at step (206) output from the model for both proposals is reviewed. Output from the model with the proposed change(s) demonstrates the impact to the sales volume that is projected with an announcement change.

The analysis shown in FIG. 2 with use of the model may be employed for a scenario where excess inventory is present or projected for a predecessor product. Ideally, the inventory needs to be reduced to mitigate overhead. In one embodiment, the model is employed with an adjustment of the new product announcement date as input to the model, with the new date allowing additional time for consumption of any excess of the predecessor product.

Changing one or more parameters of the model provides the database with a set of alternatives with estimations. More specifically, the model outputs as an analytic based dataset of a predecessor product and a new product. In one embodiment, the new analysis is based on revenue forecast on the end of product life and adjustment of impacts associated therewith, e.g. a sensitivity analysis. Following the review at step (208), it is determined if the changes input into the model require adjustment (210). In one embodiment, the adjustment may be in the form of changing the general availability date or an alternate date associated with the predecessor product, the new product, or both. Following a positive response to the determination at step (210), adjustments are proposed (212), and the process returns to step (206) for executing the model with the proposed adjustments. However, following a negative response to the determination at step (210) the sensitivity analysis concludes. The proposed date changes submitted to the model to the model may be employed for a variety of purposes including, but not limited to, identification of impact to sales volume associated with a data change, to optimize a combination of the predecessor and follow-on product revenue balanced against potential excess inventory of the predecessor product, and to minimize impact of remaining material on a current product. Accordingly, the sensitivity analysis shown herein provides insight into product movement based on date changes of the current product and/or the subsequent product.

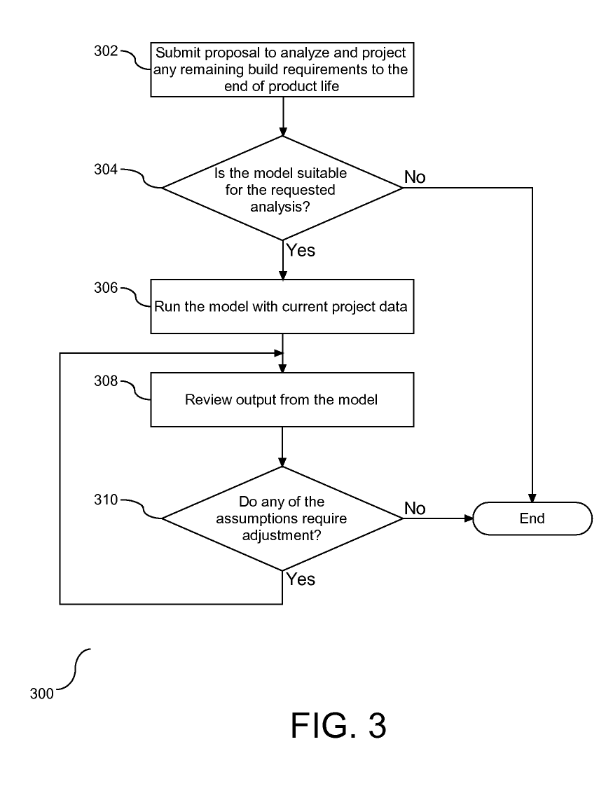

It is understood that any one product is comprised of components that make up the sum of the product. As a product life ends or nears its end, there is a need to assess the ability to service components of the product and to continue or discontinue this ability. Projecting remaining build requirements for an end of life of a predecessor product includes product components that are needed through both the end of the product sales and the end of servicing the product. FIG. 3 is a flow chart (300) illustrating a process for assessing component requirements, and specifically an estimation of the last time to purchase components. A proposal is submitted to utilize the model to analyze and project any remaining build requirements, including repairs and rebuilds, to the end of product life (302). It is then determined if the model is suitable for the requested analysis (304). A positive response to the determination at step (304) is followed by running the model with current project data, including actual announcement data and existing follow-on product announcement and general availability assumptions (306). Output from the model is reviewed (308). Specifically, the output provides insight into whether the inventory remaining coincides with the announcement schedule. One of the goals of the model is to mitigate excess inventory. In one embodiment, adjustment of the announcement date for the new product may be based on a projected excess inventory. Following step (308), it is determined if any of the assumptions require adjustments (310). A positive response to the determination at step (310) is followed by a return to step (306), and a negative response to the determinations at steps (304) and (310) conclude the component requirement assessment. Accordingly, adjustments to the model, which may include adjusting an announcement date for the new product, optimizes excess inventory of product components.

The component(s) assessment shown and described in FIG. 3 is employed to facilitate with a last time buy analysis. For example, a vendor of one or more of the product components may declare withdrawal of the component from manufacture. To ensure the ability to supply the product, the product supply team needs to know how many components to purchase in a last time buy to support the product through the end of life. The model is shown herein to use current actual data and current follow-on product assumptions to provide the quantity of product components required through the end of product life. Accordingly, the model may be employed to assist with component analysis with respect to withdrawal from market.

Forecasting the end of life of a product addresses the aspect of transitioning between generations of the product. As the product nears the end of its life, the goal is to minimize product remaining in inventory, as well as scrap material that is employed to manufacture the product. This data may be used to predict the end of life of a current product as the next generation of the product is announced or released. Similarly, this data may be used to predict the end of life of the product being released with respect to the next generation. This prediction enables more accurate inventory planning over the course of the product life and reduces excess inventory exposures during product transitions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

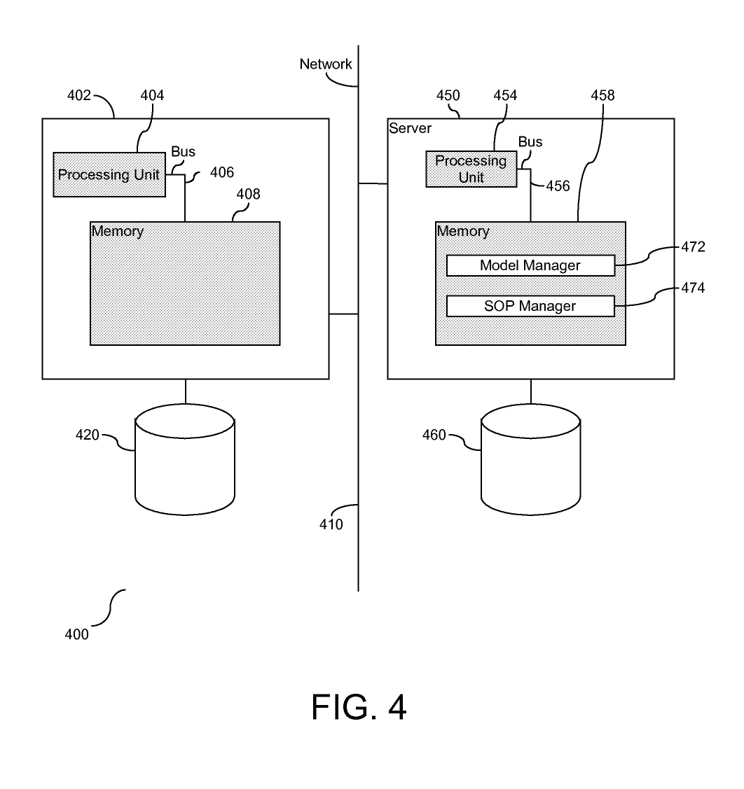

The processes shown in FIGS. 1-3 provide advantages for introduction of a new product that aids in the mitigation of inventory of a predecessor product. One advantage is that by profiling the life cycle of the prior product, sales of the product at the end of the life cycle may be predicted and used to minimize remaining inventory. The processes shown herein may be embodied as hardware components. FIG. 4 is a block diagram (400) illustrating tools and components embedded in a computer system to support inventory management and mitigation associated with a product life cycle analysis. A computer or related computing device (402) is provided in communication with data storage (420). The device (402) includes a processing unit (404) in communication with memory (408) across a bus (406). The device (402) is in communication with a server (450) across a network (410). While only one server (450) and device (402) are depicted, any number of servers and computing devices may be implemented. The server (450) includes a processing unit (454) in communication with memory (458) across a bus (456). At the same time, the server (450) is in communication with data storage (460). In one embodiment, the data storage (460) is a pool of shared storage device, also referred to herein as a cloud based resource.

One or more tools are provided in the system to support functionality associated with a statistical forecasting tool, as described in FIGS. 1-3. The tools include, but are not limited to, a model manager (472), and a SOP manager (474). Together, the tools (472) and (474) function to provide a comprehensive and accurate recommendation with respect to the SOP to drive product procurement.

The server (450) is provided with data storage (460), which in one embodiment stores the historical and current data utilized for lifecycle forecasting. In one embodiment, some or all of the data is stored on a remote data center (not shown) in communication with the server (450) across the network connection (410). The server (450) provides a venue for SOP implementation and management in support of forecasting the end of product life and granularity of product lifecycle modeling. As noted above, the model manager (472) functions in communication with the processing unit (454). More specifically, the model manager (472) employs a model forecast to assess a remainder lifecycle for a predecessor product. The model manager (472) utilizes first and second baseline curves, the first baseline curve representing shipment of the predecessor product prior to announcement of the new product and the second baseline curve representing shipment of the produce after the new product has been announced. The SOP manager (474) communicates with the model manager (472) and functions to analyze an existing SOP in view of the model. More specifically, the SOP manager (474) provides a recommendation in support of working with the existing SOP to drive procurement, or escalating one or more parameters of the SOP into a new SOP, and then employing the new SOP into the product supply chain to drive procurement.

The model manager (472) employs the model as a tool to facilitates management of product cycles, and specifically with transition between successively launched products. In one embodiment, the model manager (472) may run one or more additional cycles through the model, with each cycle having a variation of parameters of the predecessor product and/or the new product. Similarly, in one embodiment, each additional cycle identifies the effect of the change on the new product with the sales volume of the predecessor product. In another embodiment, the model may be optimized by the managers (472) and/or (474) to adjust critical dates in the life of the product, thereby allowing consumption of excess inventory of the predecessor product, e.g. mitigate remaining inventory of the predecessor product. As noted above, any one of the products subject to modeling may be comprised of component parts. During phase out of a product, it is important to mitigate inventory of components, especially components that are from a third party vendor and/or components that are not required for the subsequent product.

Historical data is employed to forecast the end of life of a current product in anticipation of announcement and release of the next generation of the product. The tools shown herein employ the processing unit(s) to support their computations for product life projections. As identified above, the tools (472) and (474) are shown residing in memory (458) of the server (450). In one embodiment, the tools (472) and (474) may be implemented as a combination of hardware and software in a shared pool of resources. Similarly, in one embodiment, the tools (472)-(474) may be combined into a single functional item that incorporates the functionality of the separate items. For example, the tools (472)-(474) may be embodied as an application in communication with the processing unit (454) and memory (458). As shown herein, each of the tools (472) and (474) are shown local to the server (450). However, in one embodiment, they may be collectively or individually distributed across a shared pool of configurable computer resources and function as a unit to support SOP modification and optimization. Accordingly, the tools may be implemented as software tools, hardware tools, or a combination of software and hardware tools.

The described features, structures, or characteristics may be combined in any suitable manner in one or more embodiments. Examples of the managers have been provided to lend a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The tools shown and described in FIG. 4 may be implemented in programmable hardware devices such as field programmable gate arrays, programmable array logic, programmable logic devices, or the like. The tool(s) may also be implemented in software for processing by various types of processors. An identified tool of executable code may, for instance, comprise one or more physical or logical blocks of computer instructions which may, for instance, be organized as an object, procedure, function, or other construct. Nevertheless, the executable of an identified tool need not be physically located together, but may comprise disparate instructions stored in different locations which, when joined logically together, comprise the tools and achieve the stated purpose of the tools.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

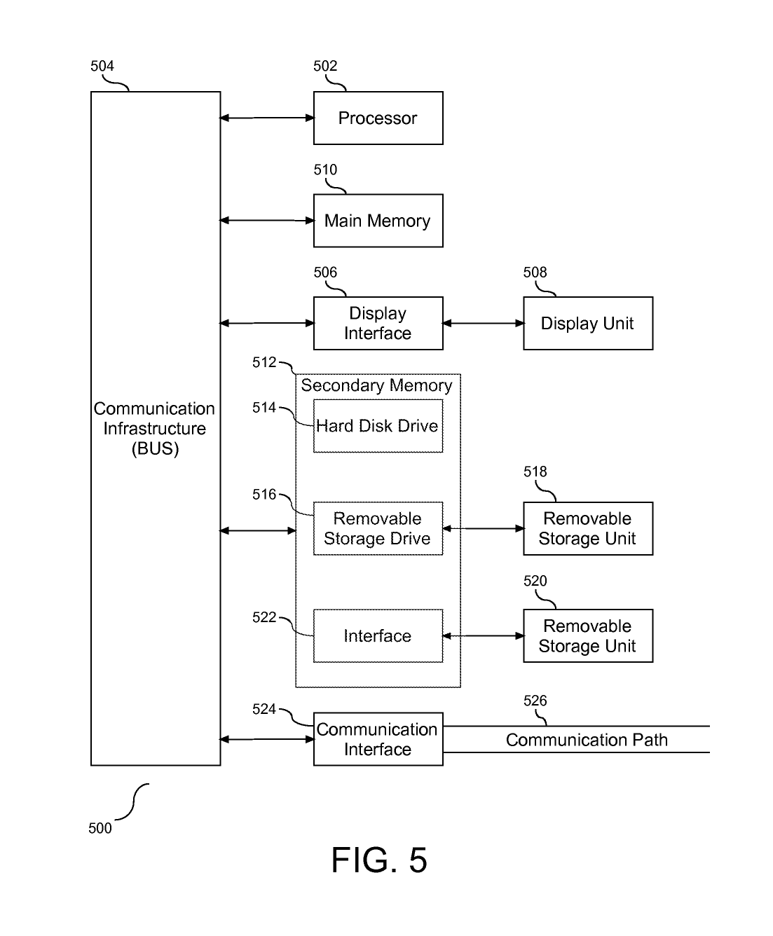

Referring now to the block diagram (500) of FIG. 5, additional details are now described with respect to implementing an embodiment of the present invention. The computer system includes one or more processors, such as a processor (502). The processor (502) is connected to a communication infrastructure (504) (e.g., a communications bus, cross-over bar, or network).

The computer system can include a display interface (506) that forwards graphics, text, and other data from the communication infrastructure (504) (or from a frame buffer not shown) for display on a display unit (508). The computer system also includes a main memory (510), preferably random access memory (RAM), and may also include a secondary memory (512). The secondary memory (512) may include, for example, a hard disk drive (514) (or alternative persistent storage device) and/or a removable storage drive (516), representing, for example, a floppy disk drive, a magnetic tape drive, or an optical disk drive. The removable storage drive (516) reads from and/or writes to a removable storage unit (518) in a manner well known to those having ordinary skill in the art. Removable storage unit (518) represents, for example, a floppy disk, a compact disc, a magnetic tape, or an optical disk, etc., which is read by and written to by a removable storage drive (516). As will be appreciated, the removable storage unit (518) includes a computer readable medium having stored therein computer software and/or data.

In alternative embodiments, the secondary memory (512) may include other similar means for allowing computer programs or other instructions to be loaded into the computer system. Such means may include, for example, a removable storage unit (520) and an interface (522). Examples of such means may include a program package and package interface (such as that found in video game devices), a removable memory chip (such as an EPROM, or PROM) and associated socket, and other removable storage units (520) and interfaces (522) which allow software and data to be transferred from the removable storage unit (520) to the computer system.

The computer system may also include a communications interface (524). Communications interface (524) allows software and data to be transferred between the computer system and external devices. Examples of communications interface (524) may include a modem, a network interface (such as an Ethernet card), a communications port, or a PCMCIA slot and card, etc. Software and data transferred via communications interface (524) are in the form of signals which may be, for example, electronic, electromagnetic, optical, or other signals capable of being received by communications interface (524). These signals are provided to communications interface (524) via a communications path (i.e., channel) (526). This communications path (526) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (510) and secondary memory (512), removable storage drive (516), and a hard disk installed in hard disk drive or alternative persistent storage device (514).

Computer programs (also called computer control logic) are stored in main memory (510) and/or secondary memory (512). Computer programs may also be received via a communication interface (524). Such computer programs, when run, enable the computer system to perform the features of the present invention as discussed herein. In particular, the computer programs, when run, enable the processor (502) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method comprising:
executing a model for forecasting a remaining lifecycle for a predecessor product, the model including a first baseline curve representing shipment of the predecessor product prior to announcement of the new product and a second baseline curve from a second constructed model representing shipment of the predecessor product after announcement of the new product; and
analyzing a sales and operating plan (SOP) versus the executed model and creating a recommendation with respect to the SOP, wherein the recommendation supporting the SOP enabling the SOP to drive procurement, and wherein the recommendation supporting changing the SOP includes escalating one or more parameters of the SOP and integrating new SOP with the escalation parameters into a product supply chain.

2. The method of claim 1, further comprising executing one or more additional cycles of the model for assessing impact on a change to announcement of the new product, the one or more cycle of the model including an alternative announcement date.

3. The method of claim 2, further comprising identifying impact to sales volume associated with the change to announcement of the new product.

4. The method of claim 2, further comprising optimizing excess inventory of the predecessor product, adjusting the announcement date for the new product with input to the model to allow consumption of any excess of the predecessor product.

5. The method of claim 1, further comprising projecting remaining build requirements for an end of life of the predecessor product, including parts need through an end of service of the predecessor product.

6. The method of claim 1, further comprising optimizing excess inventory, including adjusting an announcement date for the new product based upon excess inventory.

7. The method of claim 1, further comprising assessing inventory of product components based on changes to the SOP, including mitigating excess inventory of product components.
